(19) United States
(12) Patent Application Publication
(10) Pub. No.: US 2022/0389323 A1
(43) Pub. Date: Dec. 8, 2022

(54) SUPPORTED ZINC DIMOLYBDATE HYDROXIDE / SILICA COMPLEXES AND USES THEREOF IN POLYMER FORMULATIONS

(71) Applicant: J.M. Huber Corporation, Atlanta, GA (US)

(72) Inventors: Aleksey Isarov, Kennesaw, GA (US); Yue Liu, Marietta, GA (US); Peter Charles Hohl, Kennesaw, GA (US); Robin Brumby Helms, Ranger, GA (US)

(21) Appl. No.: 17/749,232

(22) Filed: May 20, 2022

Related U.S. Application Data
(60) Provisional application No. 63/192,634, filed on May 25, 2021.

(51) Int. Cl. C09K 21/02; C08K 3/11

(52) U.S. Cl. CPC C09K 21/02; C08K 3/11

(57) ABSTRACT

Processes for producing supported zinc dimolybdate hydroxide/silica complexes include the steps of reacting a zinc compound (such as zinc oxide) and molybdenum trioxide in an aqueous system to form a reaction mixture, and contacting the reaction mixture with silica to form the supported zinc dimolybdate hydroxide/silica complex. The resulting supported zinc dimolybdate hydroxide/silica complexes contain silica and zinc dimolybdate hydroxide at an amount in a range from 3 to 20 wt. % zinc, and generally, at least 80 wt. % of the zinc dimolybdate hydroxide is present in the form Zn₃Mo₂O₈(OH)₂. These supported zinc dimolybdate hydroxide/silica complexes are useful in polymer compositions, such as PVC-based and epoxy-based formulations.

### REFERENCE TO RELATED APPLICATION

This application claims the benefit of U.S. Provisional Application Ser. No. 63/192,634, filed on May 25, 2021, the disclosure of which is incorporated herein by reference in its entirety.

### BACKGROUND OF THE INVENTION

The present invention is directed generally to zinc dimolybdate hydroxide materials, and more particularly, to supported zinc dimolybdate hydroxide/silica complexes that can be used in polymer compositions for improved flame retardancy and reduced abrasiveness.

### SUMMARY OF THE INVENTION

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

Processes for producing supported zinc dimolybdate hydroxide/silica complexes are disclosed and described herein. One such process can comprise (i) reacting a zinc compound (zinc oxide being an illustrative example) and molybdenum trioxide (MoO₃) in an aqueous system to form a reaction mixture, and (ii) contacting (or slurrying) the reaction mixture with silica to form the supported zinc dimolybdate hydroxide/silica complex. Another process for producing supported zinc dimolybdate hydroxide/silica complexes can comprise contacting (or slurrying) zinc dimolybdate hydroxide and silica in an aqueous system to form the supported zinc dimolybdate hydroxide/silica complex.

Supported zinc dimolybdate hydroxide/silica complexes also are disclosed and described herein, and these complexes can comprise (a) silica and (b) zinc dimolybdate hydroxide at an amount in a range from 3 to 20 wt. % zinc, based on the total weight of the supported zinc dimolybdate hydroxide/silica complex. Generally, at least 80 wt. %—and often 90-100 wt. %—of the zinc dimolybdate hydroxide is present as crystalline form Zn₃Mo₂O₈(OH)₂.

Polymer compositions also are provided herein, and such compositions can comprise a polymer and any of the supported zinc dimolybdate hydroxide/silica complexes disclosed herein (e.g., produced by any of the processes disclosed herein). The relative amounts of the polymer and the supported zinc dimolybdate hydroxide/silica complex in the composition are not particularly limited, nor is the polymer type, although the supported zinc dimolybdate hydroxide/silica complexes are particularly well suited for use in PVC and epoxy-based formulations.

Both the foregoing summary and the following detailed description provide examples and are explanatory only. Accordingly, the foregoing summary and the following detailed description should not be considered to be restrictive. Further, features or variations may be provided in addition to those set forth herein. For example, certain aspects may be directed to various feature combinations and sub-combinations described in the detailed description.

### BRIEF DESCRIPTION OF THE FIGURES

FIG. 1 presents a scanning electron micrograph of the spherical fused silica component used in Example 1.

FIG. 2 presents a scanning electron micrograph of the supported zinc dimolybdate hydroxide/silica complex of Example 1.

FIG. 3 presents a scanning electron micrograph of the supported zinc dimolybdate hydroxide/silica complex of Comparative Example A.

FIG. 4 presents plots of the heat release rate (HRR) curves for the flame-retardant polymer compositions of Examples 12-15.

FIG. 5 presents photographs of drill bits before and after drilling the epoxy plaques of Examples 16-17.

FIG. 6 presents photographs of drill bits before and after drilling the epoxy plaques of Examples 18-19.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and each and every feature disclosed herein, all combinations that do not detrimentally affect the designs, compositions, processes, or methods described herein are contemplated and can be interchanged, with or without explicit description of the particular combination. Accordingly, unless explicitly recited otherwise, any aspect or feature disclosed herein can be combined to describe inventive designs, compositions, processes, or methods consistent with the present disclosure.

While compositions and methods are described herein in terms of “comprising” various components or steps, the compositions and methods also can “consist essentially of” or “consist of” the various components or steps, unless stated otherwise.

The terms “a,” “an,” and “the” are intended to include plural alternatives, e.g., at least one, unless otherwise specified.

Generally, groups of elements are indicated using the numbering scheme indicated in the version of the periodic table of elements published in Chemical and Engineering News, 63(5), 27, 1985. In some instances, a group of elements can be indicated using a common name assigned to the group; for example, alkali metals for Group 1 elements, alkaline earth metals for Group 2 elements, and so forth.

The term “contacting” is used herein to refer to materials or components which can be blended, mixed, slurried, dissolved, reacted, treated, compounded, or otherwise contacted or combined in some other manner or by any suitable method. The materials or components can be contacted together in any order, in any manner, and for any length of time, unless otherwise specified.

Molybdenum trioxide (MoO₃) often can be referred to as molybdic trioxide, molybdenum (VI) oxide, and molybdic anhydride (or molybdic acid anhydride). As one of skill in the art would readily recognize, in an (acidic) aqueous environment, molybdenum trioxide can form molybdic acid and other species such as hydrates and molybdates. Thus, when the use of molybdenum trioxide in an aqueous mixture or aqueous system is disclosed herein, this is meant to encompass any forms of molybdenum species or complexes that exist in the aqueous environment, whether molybdic acid, a hydrate, a molybdate, and the like, as well as combinations thereof.

Although any methods and materials similar or equivalent to those described herein can be used in the practice or testing of the invention, the typical methods and materials are herein described.

All publications and patents mentioned herein are incorporated herein by reference for the purpose of describing and disclosing, for example, the constructs and methodologies that are described in the publications, which might be used in connection with the presently described invention.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. As a representative example, the d50 particle size of the silica can be in certain ranges in various aspects of this invention. By a disclosure that the d50 particle size can be in a range from 0.2 to 5 μm, the intent is to recite that the d50 can be any particle size within the range and, for example, can be equal to 0.2, 0.3, 0.4, 0.5, 0.6, 0.7, 0.8, 0.9, 1, 1.5, 2, 2.5, 3, 3.5, 4, 4.5, or 5 μm. Additionally, the d50 particle size can be in any range or combination of ranges from 0.2 to 5 μm, such as from 0.2 to 2.5 μm, from 0.2 to 1 μm, or from 0.25 to 0.8 μm, and so forth. Likewise, all other ranges disclosed herein should be interpreted in a manner similar to this example. In general, an amount, size, formulation, parameter, range, or other quantity or characteristic is “about” or “approximate” whether or not expressly stated to be such.

Whether or not modified by the term “about” or “approximately,” the claims include equivalents to the quantities or characteristics.

### DETAILED DESCRIPTION OF THE INVENTION

Disclosed herein are supported zinc dimolybdate hydroxide/silica complexes containing predominantly the crystalline form Zn₃Mo₂O₈(OH)₂, methods for producing the supported zinc dimolybdate hydroxide/silica complexes, and polymer compositions and articles of manufacture containing the supported zinc dimolybdate hydroxide/silica complexes.

### Processes for Producing the Supported Complexes

Various processes for producing a supported zinc dimolybdate hydroxide/silica complex are provided herein. A first process can comprise (or consist essentially of, or consist of) (i) reacting a zinc compound and molybdenum trioxide (MoO₃) in an aqueous system to form a reaction mixture, and (ii) contacting (or slurrying) the reaction mixture with silica to form the supported zinc dimolybdate hydroxide/silica complex. A second process for producing a supported zinc dimolybdate hydroxide/silica complex can comprise (or consist essentially of, or consist of) contacting (or slurrying) zinc dimolybdate hydroxide and silica in an aqueous system to form the supported zinc dimolybdate hydroxide/silica complex.

Generally, the features of any of the processes disclosed herein (e.g., the zinc compound, the molybdenum trioxide (MoO₃), the zinc dimolybdate hydroxide, the silica, the aqueous system, and the temperature and pressure conditions under which any steps are performed, among others) are independently described herein, and these features can be combined in any combination to further describe the disclosed processes. Moreover, other process steps can be conducted before, during, and/or after any of the steps listed in the disclosed processes, unless stated otherwise. Additionally, any supported zinc dimolybdate hydroxide/silica complexes produced in accordance with any of the disclosed processes are within the scope of this disclosure and are encompassed herein.

Referring now to the first process, step (i) and step (ii) can be conducted, independently, at a temperature that typically falls within a range from 20° C. to 95° C., such as from 50° C. to 95° C., from 70° C. to 95° C., from 75° C. to 90° C., or from 80° C. to 90° C., although not limited thereto. In these and other aspects, these temperature ranges also are meant to encompass circumstances where step (i) and/or step (ii) is/are conducted at a series of different temperatures, instead of at a single fixed temperature, falling within the respective ranges. The pressure at which step (i) and step (ii) are conducted is not particularly limited, but independently can be at an elevated pressure (e.g., from 5 psig to 100 psig), at atmospheric pressure, or at any suitable sub-atmospheric pressure. In some instances, step (i) and step (ii) are conducted at atmospheric pressure, eliminating the need for pressurized vessels and their associated cost and complexity. Independently, step (i) and step (ii) can be conducted over a wide range of time periods, such as from 15 min to 24 hr, from 30 min to 12 hr, or from 90 min to 6 hr, but is not limited solely to these time periods. Other appropriate temperature, pressure, and time ranges are readily apparent from this disclosure.

In step (i), a zinc compound is reacted with molybdenum trioxide in an aqueous system to form a reaction mixture. Any suitable zinc compound can be used, such as zinc oxide, zinc chloride, or zinc nitrate, and the like. Zinc oxide is often used, since it does not introduce other elements (such as halogens or nitrogen) into the process that may need to be subsequently removed. The zinc compound and molybdenum trioxide can be contacted or reacted at a molar ratio of Zn:Mo that typically falls within a range from 1:1 to 2:1, based on the total amount of each reactant, and regardless of the order of addition or contacting of the reactants, or the addition method that is used. For instance, the molybdenum trioxide (e.g., a slurry in water) can be added slowly—at any suitable rate of addition—to zinc oxide (e.g., a solution in water) over any suitable period of time. As a skilled artisan would readily recognize, the molar ratio of Zn:Mo can vary as the reaction proceeds; therefore, the disclosed ranges of molar ratio encompass any molar ratio encountered during the reaction and formation of the reaction mixture in step (i). In further aspects of this invention, the ratio of Zn:Mo can be from 1.2:1 to 1.8:1, from 1.3:1 to 1.7:1, or from 1.4:1 to 1.6:1. For instance, the molar ratio of Zn:Mo can be a stoichiometric ratio of 1.5:1 (+/−10%), reflective of the resulting the zinc dimolybdate hydroxide having the formula, Zn₃Mo₂O₈(OH)₂.

In step (ii) of the first process, the reaction mixture (in an aqueous system) is contacted with (or slurried with) silica to form the supported zinc dimolybdate hydroxide/silica complex, while in the second process, zinc dimolybdate hydroxide is contacted with (or slurried with) silica in an aqueous system to form the supported zinc dimolybdate hydroxide/silica complex. In both processes, the aqueous system can comprise (or consist essentially of, or consist of) water. The pH of the aqueous system is not particularly limited, and as a skilled artisan would readily recognize, the pH of the aqueous system, and the pH at which the supported zinc dimolybdate hydroxide/silica complex is formed, can vary as the reactions proceeds. If desired, the aqueous system can comprise an acid or a base to modify the pH or to control the pH in a certain range during the first process and/or the second process. Referring now to the second process, the supported zinc dimolybdate hydroxide/silica complex can be formed at a temperature that typically falls within a range from 15° C. to 95° C., such as from 15° C. to 50° C., or from 20° C. to 35° C., although not limited thereto. In these and other aspects, these temperature ranges also are meant to encompass circumstances where the supported zinc dimolybdate hydroxide/silica complex is formed at a series of different temperatures, instead of at a single fixed temperature, falling within the respective ranges. The pressure at which the supported zinc dimolybdate hydroxide/silica complex is formed is not particularly limited, but can be at an elevated pressure (e.g., from 5 psig to 100 psig), at atmospheric pressure, or at any suitable sub-atmospheric pressure. In some instances, the supported zinc dimolybdate hydroxide/silica complex is formed at atmospheric pressure, eliminating the need for pressurized vessels and their associated cost and complexity. Generally, the supported zinc dimolybdate hydroxide/silica complex can be formed over a wide range of time periods, such as from 15 min to 24 hr, from 30 min to 12 hr, or from 2 hr to 6 hr, but is not limited solely to these time periods. Other appropriate temperature, pressure, and time ranges are readily apparent from this disclosure.

Optionally, the first and second processes for producing the supported zinc dimolybdate hydroxide/silica complex can further comprise a step of removing the supported zinc dimolybdate hydroxide/silica complex from water using any suitable separations technique. For example, filtration or centrifugation can be used, as well as a combination of these techniques.

Optionally, the first and second processes for producing the supported zinc dimolybdate hydroxide/silica complex can further comprise a step of drying the supported zinc dimolybdate hydroxide/silica complex using any suitable drying conditions. For example, drying temperatures ranging from 50° C. to 200° C., or from 100° C. to 150° C., can be used, and the drying can be conducted at atmospheric pressure or any suitable sub-atmospheric pressure, e.g., less than 150 Torr, or less than 50 Torr.

If desired, the first and second processes for producing the supported zinc dimolybdate hydroxide/silica complex can further comprises a step of deagglomerating the supported zinc dimolybdate hydroxide/silica complex, can further comprise a step of milling the supported zinc dimolybdate hydroxide/silica complex, or both a deagglomerating step and a milling step can be utilized.

### Supported Zinc Dimolybdate Hydroxide/Silica Complexes

Consistent with aspects of the present invention, the supported zinc dimolybdate hydroxide/silica complexes described herein (or the supported zinc dimolybdate hydroxide/silica complexes produced in accordance with any of the processes disclosed herein) can be used in variety of polymer formulations with beneficial performance properties. In an aspect, the supported zinc dimolybdate hydroxide/silica complex can comprise (a) silica and (b) zinc dimolybdate hydroxide at an amount in a range from 3 to 20 wt. % zinc, based on the total weight of the supported zinc dimolybdate hydroxide/silica complex. At least 80 wt. % of the zinc dimolybdate hydroxide can be present as crystalline form Zn₃Mo₂O₈(OH)₂.

The silica component of the supported zinc dimolybdate hydroxide/silica complex (or the silica used in a process to produce the supported zinc dimolybdate hydroxide/silica complex) often can have a median particle size (d50) in a range from 0.2 to 5 μm, from 0.2 to 25 μm, from 0.2 to 1 μm, or from 0.25 to 0.8 μm. Additionally or alternatively, the d100 particle size of the silica can be in a range from 0.6 to 10 μm, from 0.6 to 5 μm, from 0.6 to 4 μm, from 0.7 to 4 μm, or from 0.7 to 3.5 μm. Additionally or alternatively, the d10 particle size of the silica can be in a range from 0.08 to 1 μm, from 0.08 to 0.5 μm, from 0.1 to 0.5 μm, or from 0.1 to 0.4 μm. Additionally or alternatively, the silica can be characterized by a BET surface area in a range from 2 to 20 m²/g, from 4 to 15 m²/g, from 4 to 12 m²/g, from 5 to 15 m²/g, or from 5 to 13 m²/g. Other appropriate particle sizes and surface areas for the silica are readily apparent from this disclosure.

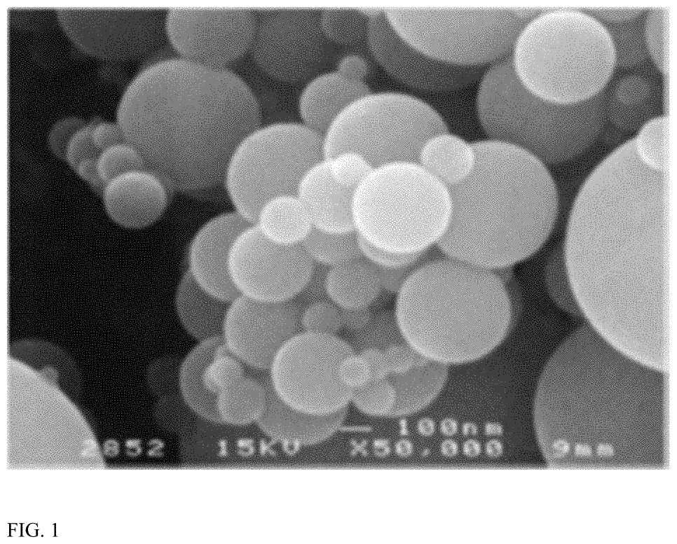

While not limited thereto, in some aspects of this invention, the silica can be a fused silica, in contrast to fumed silicas and precipitated silicas. Generally, the silica also is a spherical silica. Thus, in a particular aspect, the silica component of the supported zinc dimolybdate hydroxide/silica complex (or the silica used in a process to produce the supported zinc dimolybdate hydroxide/silica complex) is spherical fused silica. The silica is considered to be spherical if it has an average aspect ratio in a range from 1:1 to 1.4:1, and more often, the average aspect ratio is from 1:1 to 1.25:1, or from 1:1 to 1.1:1. The aspect ratio is defined herein as the longest (measurable) particle dimension divided by the shortest dimension when viewed in a 2-dimensional SEM image (e.g., FIG. 1). The average aspect ratio is the average of the aspect ratios of 10 (measurable) particles from the SEM image.

The supported zinc dimolybdate hydroxide/silica complex described herein (or the supported zinc dimolybdate hydroxide/silica complex produced by any process described herein) can contain zinc dimolybdate hydroxide at an amount in a range from 3 to 20 wt. % zinc, based on the total weight of the supported zinc dimolybdate hydroxide/silica complex. In another aspect, the supported zinc dimolybdate hydroxide/silica complex can contain from 3 to 18 wt. % zinc, from 4 to 16 wt. % zinc, in another aspect, and from 5 to 15 wt. % zinc in still another aspect. Additionally or alternatively, the supported zinc dimolybdate hydroxide/silica can contain from 3 to 20 wt. % molybdenum, such as from 3 to 18 wt. % molybdenum, from 4 to 16 wt. % molybdenum, or from 5 to 15 wt. % molybdenum.

While not being limited thereto, the supported zinc dimolybdate hydroxide/silica complex described herein (or the supported zinc dimolybdate hydroxide/silica complex produced by any process described herein) often can have a median particle size (d50) in a range from 0.3 to 6 μm, from 0.3 to 2 μm, from 0.4 to 1.8 μm, or from 0.5 to 1.7 μm. Additionally or alternatively, the d100 particle size of the supported zinc dimolybdate hydroxide/silica complex can be in a range from 1 to 12 μm, from 1 to 8 μm, from 1.5 to 7 μm, from 2 to 7 μm, or from 2.5 to 6 μm. Additionally or alternatively, the d10 particle size of the supported zinc dimolybdate hydroxide/silica complex can be in a range from 0.1 to 1.5 μm, from 0.1 to 0.8 μm, from 0.1 to 0.7 μm, or from 0.2 to 0.6 μm. Additionally or alternatively, the span ((d90-d10)/d50) of the supported zinc dimolybdate hydroxide/silica complex can be in a range from 1.5 to 5, from 1.5 to 4.5, or from 2 to 4. Additionally or alternatively, the supported zinc dimolybdate hydroxide/silica complex can be characterized by a BET surface area in a range from 3 to 20 m²/g, from 3 to 15 m²/g, from 3 to 12 m²/g, from 4 to 13 m²/g, or from 4 to 10 m²/g. Other appropriate particle sizes and surface areas for the supported zinc dimolybdate hydroxide/silica complex are readily apparent from this disclosure.

Similar to the silica, the supported zinc dimolybdate hydroxide/silica complex described herein (or the supported zinc dimolybdate hydroxide/silica complex produced by any process described herein) can be spherical (an average aspect ratio in a range from 1:1 to 1.4:1, and more often, the average aspect ratio is from 1:1 to 1.25:1, or from 1:1 to 1.1:1).

Herein, at least 80 wt. % of the zinc dimolybdate hydroxide can be present as crystalline form Zn₃Mo₂O₈(OH)₂. For instance, at least 80 wt. %, at least 85 wt. %, at least 90 wt. %, or at least 95 wt. %, can be present as Zn₃Mo₂O₈(OH)₂. Thus, substantially all (98-99.5 wt. %) or all (100 wt. %) of the zinc dimolybdate hydroxide can be present as crystalline form Zn₃Mo₂O₈(OH)₂. Other forms of zinc/molybdenum compounds include ZnMoO₄·0.8 H₂O and ZnMoO₄ (zinc molybdate).

### Polymer Compositions

This invention is also directed to, and encompasses, any compositions, formulations, composites, and articles of manufacture that contain any of the supported zinc dimolybdate hydroxide/silica complexes disclosed herein (and their respective characteristics or features, such as surface area, particle size, amount of zinc, amount of molybdenum, crystalline form, and so forth). In a particular aspect of this invention, a polymer composition is disclosed, and in this aspect, the polymer composition can comprise any suitable polymer (one or more than one) and any of the supported zinc dimolybdate hydroxide/silica complexes disclosed herein (or the supported zinc dimolybdate hydroxide/silica complexes produced by any process described herein).

In one aspect, the polymer in the polymer composition can comprise a thermoplastic polymer, while in another aspect, the polymer can comprise a thermoset polymer. In another aspect, the polymer can comprise, either singly or in any combination, a polyvinylidene chloride (PVDC), a polyvinyl chloride (PVC), a chlorinated polyvinyl chloride (CPVC), a polyvinylidene fluoride (PVDF), a polytetrafluoroethylene (PTFE), and/or an ethylene chlorotrifluoroethylene (ECTFE). In yet another aspect, the polymer can comprise a plasticized or non-plasticized PVC. In still another aspect, the polymer can comprise a rigid PVC, or alternatively, the polymer can comprise a flexible PVC. Generally, rigid PVC may be referred to as non-plasticized PVC, while flexible PVC may be referred to as plasticized PVC.

As one of skill in the art would readily recognize, PVDC can be referred to as polyvinylidene chloride, but also can be referred to as poly(vinylidene chloride). Likewise, PVC can be referred to as polyvinyl chloride, but also can be referred to as poly(vinyl chloride).

In an aspect, the polymer can comprise an epoxy resin. For instance, the polymer can comprise, either singly or in any combination, a bisphenol A epoxy resin, a bisphenol F epoxy resin, a bisphenol S epoxy resin, a phenol novolac epoxy resin, a cresol novolac epoxy resin, a bisphenol A novolac epoxy resin, a bisphenol F novolac epoxy resin, a diphenylethylene epoxy resin, an epoxy resin having a triazine skeleton, an epoxy resin having a fluorene skeleton, a triphenylmethane epoxy resin, a biphenyl epoxy resin, a xylylene epoxy resin, a biphenyl aralkyl epoxy resin, a naphthalene epoxy resin, a dicyclopentadiene epoxy resin, and/or an alicyclic epoxy resin.

While not being limited thereto, the amount of the supported zinc dimolybdate hydroxide/silica complex in the polymer composition often can range from 1 to 50 phr (parts by weight per hundred parts of resin). Illustrative and non-limiting amounts of the supported zinc dimolybdate hydroxide/silica complex in the polymer composition, therefore, can include the following ranges: from 5 to 50 phr, from 2 to 40 phr, from 5 to 40 phr, from 10 to 50 phr, from 10 to 40 phr, from 10 to 30 phr, or from 15 to 40 phr. Other appropriate ranges for the amount of the supported zinc dimolybdate hydroxide/silica complex in the polymer composition are readily apparent from this disclosure.

Optionally, the polymer composition can further comprise any suitable additive, non-limiting examples of which can include a stabilizer, a lubricant, an inorganic flame retardant (e.g., aluminum trihydrate or magnesium hydroxide), a filler, a colorant, a curing agent, a catalyst or accelerator, or a fiber (e.g., glass fiber, carbon fiber, paper fiber, nonwoven fiber), and the like, as well as combinations thereof.

Articles of manufacture can be formed from and/or can comprise any of the polymer compositions described herein. In one aspect, the article of manufacture can comprise a wire or cable, while in another aspect, the article can comprise a printed circuit board. Other appropriate articles of manufacture and end-use applications are readily apparent from this disclosure.

For instance, the spherical zinc dimolybdate hydroxide/silica complexes can be utilized in at least three applications in industrial composite prepregs, as well as in microelectronic manufacturing to provide benefits in enhanced properties of finished products and improved manufacturing processes. The first application is in printed circuit boards (PCBs), the second application is in epoxy molding compounds (EMCs) as in microchip packaging, and the third application is industrial composite prepregs where flame retardancy as well as drilling are required, such as aerospace and automotive end-uses.

Printed circuit boards (PCBs) are ubiquitous in electronics in consumer and industrial products, including televisions, cell phones, and computers. Manufacturers commonly produce circuit boards with flame-retardant chemicals to help ensure fire safety. The flame retardant may prevent the fire from developing altogether or slow down the build-up phase of the fire by delaying the onset of flash over, thereby extending the escape time window. In either case, the flame retardant serves its primary purpose of reducing the risk of fire-related fatalities. Some flame-retardant chemicals, however, have caused growing concerns about their fate and toxicity if released into the environment. Such is the case for tetrabromobisphenol-A or TBBPA. TBBPA is the most widely used flame retardant for PCBs. Herein, a single composition offers several benefits including halogen-free flame retardancy, drilling improvements, thermal expansion control, and dimension stability.

A basic PCB consists of a flat sheet of insulating material and a layer of copper foil, laminated to the substrate. Chemical etching divides the copper into separate conducting lines called tracks or circuit traces, pads for connections, vias to pass connections between layers of copper, and features such as solid conductive areas for electromagnetic shielding or other purposes. A printed circuit board can have multiple copper layers. A two-layer board has copper on both sides; multi-layer boards sandwich additional copper layers between layers of insulating material. Conductors on different layers are connected with vias, which are copper-plated holes that function as electrical tunnels through the insulating substrate. Through-hole component leads sometimes also effectively function as vias. The “through-hole” components are mounted by their wire leads passing through the board and soldered to traces on the other side. Through-hole manufacture adds to board cost by requiring many holes to be drilled accurately. Holes through a PCB with a diameter larger than 76.2 micrometers are typically drilled with drill bits made of solid coated tungsten carbide. Beneficially, the disclosed compositions have high thermal stability, suitable for lead-free soldering.

Important characteristics are the level to which the laminate is fire retardant, the dielectric constant (er), the loss factor (tδ), the tensile strength, the shear strength, the glass transition temperature (Tg), and the Z-axis expansion coefficient (how much the thickness changes with temperature). Thermal expansion is an important consideration especially with ball grid array (BGA) and naked die technologies, and glass fiber generally offers the best dimensional stability. With decreasing size of board features and increasing frequencies, small non-homogeneities like uneven distribution of fiberglass or other filler, thickness variations, and bubbles in the resin matrix, and the associated local variations in the dielectric constant, are gaining importance. The small particle size of the disclosed supported complexes in consistent with these concerns.

The complexes described herein can be used as fillers in epoxy molding compound (EMC). Epoxy molding compounds are widely used to encapsulate semiconductor devices due to superior properties such as high mechanical strength and high productivity. Generally, in doing so, liquid epoxy polymers are injected over a circuit and cured to solid for protection. Herein, the supported complexes impart an extremely low coefficient of thermal expansion (CTE), good dimension stability, as well as flame retardancy to the semiconductor device packaging without significantly increasing viscosity during manufacturing processes.

Referring to industrial composite prepreg applications, prepreg stands for “pre-impregnated” composite fibers. More specifically, prepregs are composite materials where reinforcement fiber is pre-impregnated with a thermoplastic or thermoset resin matrix. It is a composite material form that requires additional conversion or fabrication into a final, fully cured, part. Epoxy resins are the most common thermoset polymer matrix material. The fibers often take the form of a weave and the matrix is used to bond them together and to other components during manufacture. The thermoset matrix is only partially cured to allow easy handling. This partially cured epoxy material is also called B-Stage material. Composite prepregs increasingly find use in high performance applications in various industrial sectors. Some examples of the use of prepregs are aircraft interiors, aerospace components, aircraft flooring, cargo liners, automotive parts and components, tooling, ballistic panels, electronic-transmission applications, sporting goods, high-rise flooring, high impact floor surfaces, rotor blades in wind turbines, and orthopedic technology in orthotics as well as in prosthetics. Added as a filler, the supported complexes described herein provide required flame retardancy, very low coefficient of thermal expansion (CTE), and good dimensional stability. In applications where drilling of the composites is required, the supported zinc dimolybdate hydroxide/silica complexes also improve drillability by reducing drilling defects, extending drill bit life, and reducing down time.

The supported complexes also can be used in Thermal Interface Materials due to high thermal conductivity and the low viscosity resulting from the sphericity of particles. The supported complex (or the silica, or both the supported complex and the silica) also may be surface treated with silane and/or other surfactants, such as epoxy silane, phenylamino silane, methacryl silane, isocyanate silane, and the like. After surface treatment, improved compound properties can be achieved. The benefits include lower resin compound viscosity, better compatibility with polymer resins, and less agglomerations.

If desired, closed packing technology can be applied to the supported complexes, such as, for instance, combinations of larger silica particles with smaller silica particles (e.g., a bimodal particle size distribution) instead of a single particle size distribution. This can improve compound viscosity at very high loading levels (up to 80 wt. %, or more).

### EXAMPLES

The invention is further illustrated by the following examples, which are not to be construed in any way as imposing limitations to the scope of this invention. Various other aspects, modifications, and equivalents thereof which, after reading the description herein, may suggest themselves to one of ordinary skill in the art without departing from the spirit of the present invention or the scope of the appended claims.

The d50 particle size, or median particle size, refers to the particle size for which 50% of the sample by weight has a smaller size and 50% of the sample has a larger size. Particle size measurements (inclusive of d10, d50, d90, and d100) were determined by laser diffraction in accordance with ISO 13320 using a Beckman Coulter LS 13 320 Single-Wavelength Laser Diffraction Particle Size Analyzer.

BET surface areas were determined using the BET nitrogen adsorption method of Brunauer et al., J. Am. Chem. Soc., 60, 309 (1938) using a Micromeritics TriStar II Surface Area and Porosity Analyzer.

### Examples 1-11 and Comparative Example A

In Example 1, 161.8 g (1988 mmol) of zinc oxide (d50 of 0.31 um, Zochem Inc.) and 1.25 L of deionized water were placed into a reactor vessel equipped with a stirrer and a thermoregulator, and heated with stirring at 85° C. Separately, 191.2 g (1328.4 mmol) of molybdenum trioxide (Langeloth Metallurgical Company) and 382.5 g of deionized water were added to a beaker at 85° C. to create a slurry. Once both were well mixed, the molybdenum trioxide slurry was pumped into the reactor vessel containing the zinc oxide solution at 30 mL/min with a peristaltic pump. The reaction mixture was then stirred for 1 hour at 85° C. before adding 1412 g of spherical fused silica (nominal d50 of 0.6 um, d10 of 0.3 um, d100 of 3 um, and BET surface area of 6.2 m²/g; Denka Company Limited; FIG. 1 illustrates the sphericity of the fused silica), then stirred for an additional 6 hours. The product mixture was then poured into a glass pan and dried in an oven at 120° C. overnight. The dried product was deagglomerated in a Henschel at 1800 rpm for 3 minutes followed by hammer milling to reduce to a specified particle size distribution.

In Example 2A, 323.6 g (3976 mmol) of zinc oxide (d50 of 0.31 um) and 2.5 L of deionized water were placed into a reactor vessel, and heated with stirring at 85° C. Separately, 382.4 g (2656.7 mmol) of molybdenum trioxide and 765 g of deionized water were added to a beaker at 85° C. to create a slurry. Once both were well mixed, the molybdenum trioxide slurry was pumped into the reactor vessel containing the zinc oxide solution at 30 mL/min with a peristaltic pump. The reaction mixture was then stirred for 1 hour at 85° C. before adding 2824 g of spherical fused silica (nominal d50 of 0.4 um, d10 of 0.2 um, d100 of 0.8 um, and BET surface area of 11.3 m²/g; Denka Company Limited), then stirred for an additional 6 hours. The product mixture was then poured into a glass pan and dried in an oven at 120° C. overnight. The dried product was deagglomerated in a Henschel at 1800 rpm for 3 minutes followed by hammer milling to reduce to a specified particle size distribution.

In Example 2B, 323.6 g (3976 mmol) of zinc oxide (d50 of 0.31 um) and 2.5 L of deionized water were placed into a reactor vessel, and heated with stirring at 85° C. Separately, 382.4 g (2656.7 mmol) of molybdenum trioxide and 765 g of deionized water were added to a beaker at 85° C. to create a slurry. Once both were well mixed, the molybdenum trioxide slurry was pumped into the reactor vessel containing the zinc oxide solution at 30 mL/min with a peristaltic pump. The reaction mixture was then stirred for 1 hour at 85° C. before adding 1059 g of spherical fused silica (d50 of 0.4 um), then stirred for an additional 6 hours. The product mixture was then poured into a glass pan and dried in an oven at 120° C. overnight. The dried product was then deagglomerated in a Henschel at 1800 rpm for 3 minutes followed by hammer milling to reduce to a specified particle size distribution.

In Example 3, 50 g (614.3 mmol) of zinc oxide (d50 of 0.12 um, Zochem Inc.) and 2.4 L of deionized water were placed into a reactor vessel, and heated with stirring at 85° C. Separately, 62.5 g (434.2 mmol) of molybdenum trioxide and 125 g of deionized water were added to a beaker at 85° C. to create a slurry. Once both were well mixed, the molybdenum trioxide slurry was pumped into the reactor vessel containing the zinc oxide solution at 10 mL/min with a peristaltic pump. The reaction mixture was then stirred for 1 hour at 85° C. before adding 535 g of spherical fused silica (d50 of 4.12 um, Imerys), then stirred for an additional 2 hours. The product mixture was poured into a glass pan and dried in an oven at 120° C. overnight. The dried product was deagglomerated in a Henschel at 1800 rpm for 3 minutes followed by hammer milling to reduce to a specified particle size distribution.

In Example 4, 25 g (307.2 mmol) of zinc oxide (d50 of 0.12 um) and 2.4 L of deionized water were placed into a reactor vessel, and heated with stirring at 85° C. Separately, 31.3 g (217.5 mmol) of molybdenum trioxide and 125 g of deionized water were added to a beaker at 85° C. to create a slurry. Once both were well mixed, the molybdenum trioxide slurry was pumped into the reactor vessel containing the zinc oxide solution at 10 mL/min with a peristaltic pump. The reaction mixture was then stirred for 1 hour at 85° C. before adding 535 g of spherical fused silica (d50 of 4.12 um), then stirred for an additional 2 hours. The product mixture was poured into a glass pan and dried in an oven at 120° C. overnight. The dried product was deagglomerated in a Henschel at 1800 rpm for 3 minutes followed by hammer milling to reduce to a specified particle size distribution.

In Example 5, 28 g (344 mmol) of zinc oxide (d50 of 0.12 um) and 2.4 L of deionized water were placed into a reactor vessel, and heated with stirring at 85° C. Separately, 31.3 g (217.5 mmol) of molybdenum trioxide and 125 g of deionized water were added to a beaker at 85° C. to create a slurry. Once both were well mixed, the molybdenum trioxide slurry was pumped into the reactor vessel containing the zinc oxide solution at 10 mL/min with a peristaltic pump. The reaction mixture was then stirred for 1 hour at 85° C. before adding 535 g of spherical fused silica (d50 of 0.6 um), then stirred for an additional 2 hours. The product mixture was poured into a glass pan and dried in an oven at 120° C. overnight. The dried product was deagglomerated in a Henschel at 1800 rpm for 3 minutes followed by hammer milling to reduce to a specified particle size distribution.

In Example 6, 28 g (344 mmol) of zinc oxide (d50 of 0.12 um) and 2.4 L of deionized water were placed into a reactor vessel, and heated with stirring at 85° C. Separately, 31.3 g (217.5 mmol) of molybdenum trioxide and 125 g of deionized water were added to a beaker at 85° C. to create a slurry. Once both were well mixed, the molybdenum trioxide slurry was pumped into the reactor vessel containing the zinc oxide solution at 10 mL/min with a peristaltic pump. The reaction mixture was then stirred for 1 hour at 85° C. before adding 535 g of spherical fused silica (d50 of 0.6 um), then stirred for an additional 6 hours. The product mixture was poured into a glass pan and dried in an oven at 120° C. overnight. The dried product was deagglomerated in a Henschel at 1800 rpm for 3 minutes followed by hammer milling to reduce to a specified particle size distribution.

In Example 7, 28 g (344 mmol) of zinc oxide (d50 of 0.12 um) and 2.4 L of deionized water were placed into a reactor vessel, and heated with stirring at 85° C. Separately, 31.3 g (217.5 mmol) of molybdenum trioxide and 125 g of deionized water were added to a beaker at 85° C. to create a slurry. Once both were well mixed, the molybdenum trioxide slurry was pumped into the reactor vessel containing the zinc oxide solution at 10 mL/min with a peristaltic pump. The reaction mixture was then stirred for 1 hour at 85° C. before adding 1070 g of spherical feud silica (d50 of 0.6 um), then stirred for an additional 6 hours. The product mixture was poured into a glass pan and dried in an oven at 120° C. overnight. The dried product was deagglomerated in a Henschel at 1800 rpm for 3 minutes followed by hammer milling to reduce to a specified particle size distribution.

In Example 8, 50 g (614.3 mmol) of zinc oxide (d50 of 0.12 um) and 2.4 L of deionized water were placed into a reactor vessel, and heated with stirring at 50° C. Separately, 62.5 g (434.2 mmol) of molybdenum trioxide and 125 g of deionized water were added to a beaker at 50° C. to create a slurry. Once both were well mixed, the molybdenum trioxide slurry was pumped into the reactor vessel containing the zinc oxide solution at 10 mL/min with a peristaltic pump. The reaction mixture was then stirred for 1 hour at 50° C. before adding 535 g of spherical silica (d50 of 0.6 um), then stirred for an additional 6 hours. The product mixture was poured into a glass pan and dried in an oven at 120° C. overnight. The dried product was deagglomerated in a Henschel at 1800 rpm for 3 minutes followed by hammer milling to reduce to a specified particle size distribution.

In Example 9, 50 g (614.3 mmol) of zinc oxide (d50 of 0.12 um) and 2.4 L of deionized water were placed into a reactor vessel, and stirred at room temperature. Separately, 62.5 g (434.2 mmol) of molybdenum trioxide and 125 g of deionized water were added to a beaker at room temperature to create a slurry. Once both were well mixed, the molybdenum trioxide slurry was pumped into the reactor vessel containing the zinc oxide solution at 10 mL/min with a peristaltic pump. The reaction mixture was then stirred for 1 hour at room temperature before adding 1070 g of spherical silica (d50 of 0.6 um), then stirred for an additional 6 hours. The product mixture was poured into a glass pan and dried in an oven at 120° C. overnight. The dried product was deagglomerated in a Henschel at 1800 rpm for 3 minutes followed by hammer milling to reduce to a specified particle size distribution.

In Example 10, zinc dimolybdate hydroxide was produced in a manner similar to Example 1, but the reaction mixture slurry (without addition of silica) was flash dried and then deagglomerated with a Mikro ACM air classifying mill to form the zinc dimolybdate hydroxide at a d50 of 3.3 um. Then, 100 g of the zinc dimolybdate hydroxide, 400 g of spherical fused silica (d50 of 0.6 um), and 700 g of deionized water were placed into the grinding tank of an attritor mill without grinding media. The slurry mixture was then stirred for 6 hours at 600 rpm at approximately 22° C. The product mixture was poured into a glass pan and dried in an oven at 110° C. overnight. The dried product was deagglomerated in a Henschel at 1800 rpm for 3 minutes followed by hammer milling to reduce to a specified particle size distribution.

In Example 11, 20 g of zinc dimolybdate hydroxide (produced in a manner similar to Example 10, d50 of 3.3 urn) and 80 g of spherical fused silica (d50 of 0.6 um) were placed into a polypropylene bottle, and the bottle was placed in a modified Blue M oven to tumble overnight at approximately 22° C.

The spherical zinc dimolybdate hydroxide/silica complexes produced in Examples 1-11 generally had d10 particle sizes ranging from 0.3 to 0.5 um, d50 particle sizes ranging from 0.6 to 1.5 um, d100 particle sizes ranging from 4 to 5 um, particle size spans ranging from 2.5 to 3, and BET surface areas ranging from 5.5 to 9 m²/g. These complexes also had a zinc content of approximately 7 wt. % and a molybdenum content of approximately 7 wt. %, with the exception of Example 2B, which had zinc and molybdenum contents, independently, of approximately 14 wt. %.

Comparative Example A was produced using the same silica as in Example 1, but with the procedure described in U.S. Pat. No. 6,190,787, in which molybdenum trioxide and silica were first combined, followed by the addition of zinc oxide. The complex obtained in Comparative Example A was compared with Example 1 (and representative of the other Examples) using XRD analyses to determine differences in crystal structure. The powder samples were loaded into a Panalytical X′pert MPD diffractometer using Cu radiation at 45KV/40 mA. Scans were run over the range of 6° to 80° with a step size of 0.0131° and a counting time of 250 seconds per step. Once the diffraction patterns were obtained, the phases were identified with the aid of the Powder Diffraction File published by the International Centre for Diffraction Data or the Inorganic Crystal Structure Database. The XRD data indicated ˜25 wt. % of an amorphous phase due to the silica, which was subtracted out to result in the crystalline phase breakdown shown in Table I. Surprisingly, Example 1 was effectively all (˜99 wt. %) zinc dimolybdate hydroxide—Zn₃Mo₂O₈(OH)₂—whereas Comparative Example A contained only ˜60 wt. % Zn₃Mo₂O₈(OH)₂, plus ˜15 wt. % of a hydrate—ZnMoO₄·0.8 H₂O—and 25 wt. % of an unknown crystalline phase(s).

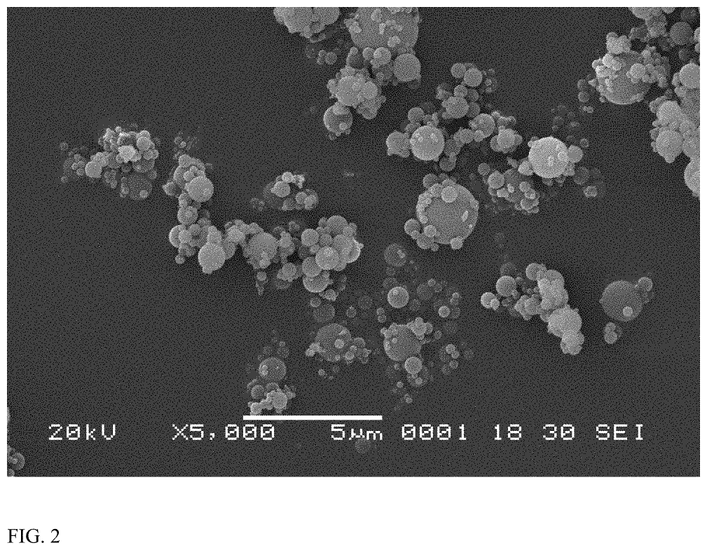

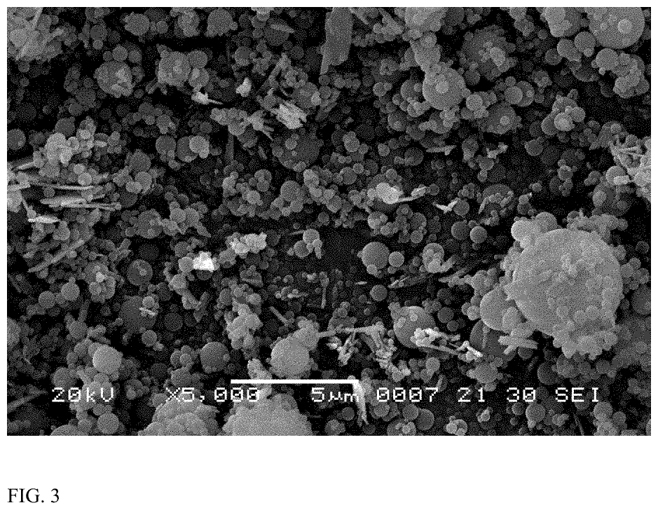

Zinc and molybdenum-containing compounds can be difficult to attach sufficiently onto the silica base material. To demonstrate the improvements disclosed herein, FIG. 2 is a scanning electron micrograph (SEM) of the supported zinc dimolybdate hydroxide/silica complex of Example 1, while FIG. 3 is a SEM of the complex of Comparative Example A. Beneficially, FIG. 2 shows much greater attachment of the zinc dimolybdate hydroxide to the silica, in contrast to FIG. 3, where there are much more unsupported zinc molybdate particles that are unattached to the base silica support.

### Examples 12-15

In Examples 13-15, zinc dimolybdate hydroxide/silica complexes were incorporated into plasticized polyvinyl chloride using a two-step melt blend compounding process. In the first step, PVC, plasticizer, stabilizer, lubricant, antimony trioxide, ATH, and MgOH₂ were mixed at a temperature of 90° C. using a Henschel mixer to form a PVC pre-mix with the composition shown in Table II. In the second step, 24.64 g of the zinc dimolybdate hydroxide/silica complex were added to 350.36 g of the PVC pre-mix, and then mixed at 165° C. and 45 rpm for 5 min using a Brabender Intelli-Torque Plasti-Corder mixer equipped with roller blades. Samples for analysis were prepared by pressing the material with a Givin PHI hydraulic press at a pressure of 78.3 bar and a temperature of 196° C. Example 12 utilized the PVC pre-mix only, while Examples 13-15 utilized the zinc dimolybdate hydroxide/silica complexes of Examples 9-11, respectively. Table III summarizes Examples 12-15 with values in phr.

A cone calorimeter (DEATAK CC-2) was used for flame resistance testing on samples following the procedure described in ASTM E 1354. Specimens measuring 100 mm×100 mm×0.635 mm were exposed in a horizontal orientation. An external heat flux of 50 kW/m² was used for the experiments. Measured parameters included Time to Sustained Ignition, Peak Rate Release Rate (PHRR), Average Rate of Heat release (RHR) over 60 seconds, Total Heat Released (THR), Avg Effective Heat of Combustion, Initial Mass, Final Mass, Sample Mass Loss, Avg Mass Loss Rate (10% to 90%), Avg SEA, Maximum Average Rate of Heat Evolved (MARHE), Total Smoke Production, and Average Normalized Total Smoke Production. Reported data was the average of 3 experiments.

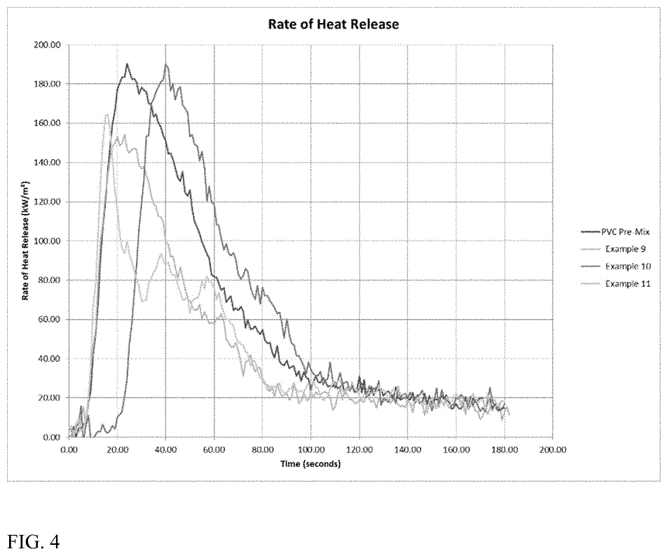

FIG. 4 illustrates the heat release rate (HRR) curves for the four flame retardant polymer compositions of Examples 12-15, and Table IV summarizes the flame-retardant properties (from FIG. 4). Beneficially, and unexpectedly, the flame retardant compositions of Examples 13-15 (containing zinc dimolybdate hydroxide/silica complexes) each had lower Peak Heat Release Rate (PHRR; Example 13 had the lowest PHRR), Total Heat Released (THR; Example 15 has the lowest THR), and Maximum Average Rate of Heat Evolved (MARHE; Example 14 has the lowest MARHE) values than Example 12. Additionally, the Total Smoke Production and the Average Normalized Total Smoke Production were significantly lower for Examples 13-15 than for Example 12.

### Examples 16-19

In Examples 16-19, silica or zinc dimolybdate hydroxide/silica complexes were incorporated into epoxy resins with the compositions shown in Table V (values in phr). Examples 17-19 utilized the zinc dimolybdate hydroxide/silica complexes of Examples 1, 2B, and 2A, respectively. Example 16 utilized only silica. For each example, 10 plaques measuring 100×100×7 mm were tested for wear and abrasiveness to milling/drilling bits during the removal of a 2 mm thick layer of the plaques.

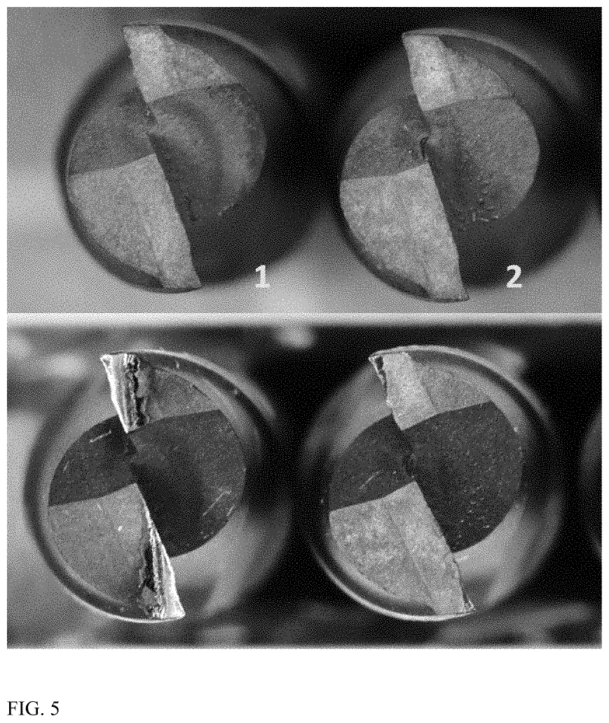

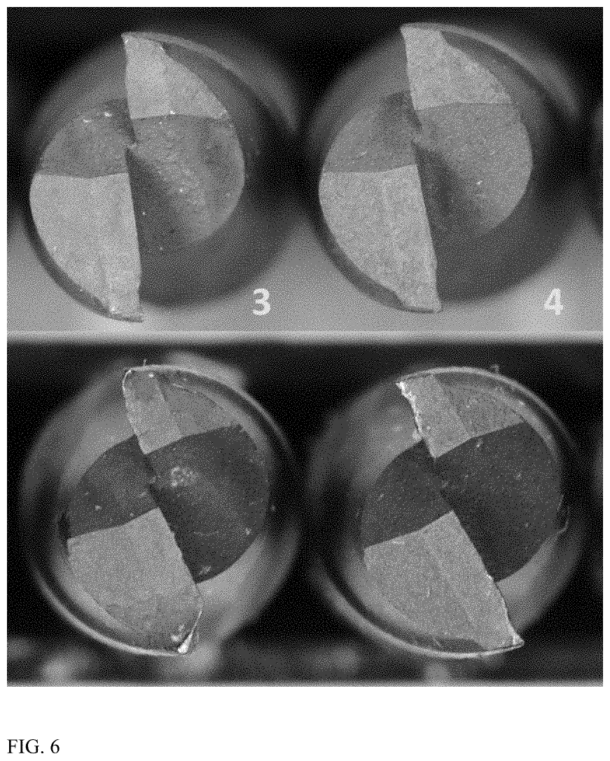

FIG. 5 illustrates the drill bits before (top) and after (bottom) drilling the epoxy plaques of Example 16 (labeled 1) and Example 17 (labeled 2), while FIG. 6 illustrates the drill bits before (top) and after (bottom) drilling the epoxy plaques of Example 18 (labeled 3) and Example 19 (labeled 4). Unexpectedly, and beneficially, the bottom (post milling) images show that the epoxy plaques loaded with 5 phr spherical silica and 25 phr of the supported zinc dimolybdate hydroxide/silica complexes (Examples 17-19) performed much better—less wear and lower abrasiveness—than epoxy plaques loaded with 30 phr spherical silica (Example 16) in terms of drilling processability. From most abrasive to least abrasive, Example 16 (labeled 1), then Example 17 (labeled 2) and Example 19 (labeled 4), then Example 18 (labeled 3). The abrasiveness correlated with the content of zinc/molybdenum: Example 16 contained none and was the most abrasive, while Example 18 contained the most and was the least abrasive. Examples 17 and 19 contained the same amount of zinc/molybdenum but with a different silica particle size; thus, the particle size had little effect on abrasiveness as compared to the amount of zinc/molybdenum in the epoxy formation.

TABLE I
Crystalline Phase Analysis (wt. %).

| | Example 1 | Comparative Example A |
|---|---|---|
| Zn₃Mo₂O₈(OH)₂ | ~99 | ~60 |
| ZnMoO₄•0.8 H₂O | ~1 | ~14.7 |
| Unknown Phase(s) | — | ~25.3 |

TABLE II
PVC Pre-Mix Composition.

| Ingredient | Description | PHR | Wt. % | Grams |
|---|---|---|---|---|
| PVC Resin | GA Gulf 5415 (K70) | 100 | 46.88 | 1406.47 |
| Plasticizer | TOTM | 48 | 22.50 | 675.11 |
| Stabilizer | Ca/Zn Chemson | 3 | 1.41 | 42.19 |
| Lubricant | Acid | 0.3 | 0.14 | 4.22 |
| Sb₂O₃ | Antimony | 2 | 0.94 | 28.13 |
| ATH | H710 | 43 | 20.16 | 604.78 |
| Mag | V90SF | 17 | 7.97 | 239.10 |
| Total | | 213.3 | 100 | 3000 |

TABLE III
Examples 12-15.

| Example | 12 | 13 | 14 | 15 |
|---|---|---|---|---|
| Pre-Mix | 360 | 336.35 | 336.35 | 336.35 |
| Example 9 | | 23.65 | | |
| Example 10 | | | 23.65 | |
| Example 11 | | | | 23.65 |
| Total | 360 | 360 | 360 | 360 |

TABLE IV
Summary of ASTM E1354 Test Results.

| | | | Example 13 | Example 14 | Example 15 |
|---|---|---|---|---|---|
| | | Example 12 | using | using | using |
| Test | Units | PVC Pre-Mix | Example 9 | Example 10 | Example 11 |
| Time to Sustained Ignition | Seconds | 10.99 | 9.64 | 9.57 | 9.83 |
| Peak Heat Release Rate (PHRR) | kW/m² | 197.68 | 157.23 | 193.30 | 186.17 |
| Average RHR over 60 seconds | kW/m² | 130.18 | 97.10 | 104.65 | 86.20 |
| Average RHR over 180 seconds | kW/m² | 29.33 | 0.00 | 0.00 | 0.00 |
| Average RHR over 300 seconds | kW/m² | 0.00 | 0.00 | 0.00 | 0.00 |
| Total Heat Released (THR) | MJ/m² | 11.17 | 8.20 | 10.00 | 7.87 |
| Avg Effective Heat of Combustion | MJ/kg | 14.22 | 12.61 | 13.80 | 11.63 |
| Initial Mass | g | 9.77 | 9.57 | 10.60 | 9.57 |
| Final Mass | g | 1.88 | 2.98 | 3.34 | 2.77 |
| Sample Mass Loss | kg/m² | 0.79 | 0.66 | 0.73 | 0.68 |
| Avg Mass Loss Rate (10% to 90%) | g/m²s | 7.70 | 8.77 | 7.90 | 7.50 |
| Avg SEA | m²/kg | 814.06 | 747.57 | 605.99 | 739.47 |
| CO Yield | kg/kg | 0.00 | 0.00 | 0.00 | 0.00 |
| CO2 Yield | kg/kg | 0.00 | 0.00 | 0.00 | 0.00 |
| Total Smoke Production | m²/m² | 641.02 | 491.63 | 440.35 | 502.70 |
| Maximum Average Rate of Heat | kW/m² | 249.19 | 196.69 | 182.66 | 182.91 |
| Evolved (MARHE) | | | | | |
| Average Normalized Total | m²/m²/g | 65.56 | 51.46 | 41.64 | 52.50 |
| Smoke Production | | | | | |

TABLE V
Epoxy Formulations.

| Ingredient | 16 | 17 | 18 | 19 |
|---|---|---|---|---|
| Epon 828 Epoxy Resin | 100 | 100 | 100 | 100 |
| Epikure 3300 Curing Agent | 24.4 | 24.4 | 24.4 | 24.4 |
| Spherical Fused Silica | 30 | 5 | 5 | 5 |
| (nominal d50 of 0.6 um) | | | | |
| Example 1 | | 25 | | |
| Example 2B | | | 25 | |
| Example 2A | | | | 25 |

The invention is described above with reference to numerous aspects and specific examples. Many variations will suggest themselves to those skilled in the art in light of the above detailed description. All such obvious variations are within the full intended scope of the appended claims. Other aspects of the invention can include, but are not limited to, the following (aspects are described as “comprising” but, alternatively, can “consist essentially of” or “consist of”):

Aspect 1. A process for producing a supported zinc dimolybdate hydroxide/silica complex, the process comprising: (i) reacting a zinc compound (e.g., zinc oxide, zinc chloride, zinc nitrate) and molybdenum trioxide (MoO₃) in an aqueous system to form a reaction mixture; and (ii) contacting (or slurrying) the reaction mixture with silica to form the supported zinc dimolybdate hydroxide/silica complex.

Aspect 2. The process defined in aspect 1, wherein step (i) and step (ii) are conducted independently at a temperature in any suitable range, or in any range disclosed herein, e.g., from 20° C. to 95° C., from 50° C. to 95° C., from 75° C. to 90° C., or from 80° C. to 90° C.

Aspect 3. The process defined in aspect 1 or 2, wherein the zinc compound and the molybdenum trioxide are reacted at a molar ratio of Zn:Mo in any suitable range, or in any range of Zn:Mo disclosed herein, e.g., from 1:1 to 2:1, from 1.2:1 to 1.8:1, from 1.3:1 to 1.7:1, or from 1.4:1 to 1.6:1, based on the total amount of each reactant. Aspect 4. The process defined in any one of the preceding aspects, wherein step (i) and step (ii) are conducted independently at a pressure in any suitable range, or in any range disclosed herein, e.g., from 5 psig to 100 psig, at atmospheric pressure, or at a sub-atmospheric pressure.

Aspect 5. A process for producing a supported zinc dimolybdate hydroxide/silica complex, the process comprising contacting (or slurrying) zinc dimolybdate hydroxide and silica in an aqueous system to form the supported zinc dimolybdate hydroxide/silica complex.

Aspect 6. The process defined in aspect 5, wherein the supported zinc dimolybdate hydroxide/silica complex is formed at a temperature in any suitable range, or in any range disclosed herein, e.g., from 15° C. to 95° C., from 15° C. to 50° C., or from 20° C. to 35° C.

Aspect 7. The process defined in aspect 5 or 6, wherein the supported zinc dimolybdate hydroxide/silica complex is formed at a pressure in any suitable range, or in any range disclosed herein, e.g., from 5 psig to 100 psig, at atmospheric pressure, or at a sub-atmospheric pressure.

Aspect 8. The process defined in any one of the preceding aspects, further comprising a step of removing the supported zinc dimolybdate hydroxide/silica complex from water using any suitable technique, or any technique disclosed herein, e.g., filtration or centrifugation, as well as combinations thereof.

Aspect 9. The process defined in any one of the preceding aspects, further comprising a step of drying the supported zinc dimolybdate hydroxide/silica complex under any suitable drying conditions, or any drying conditions disclosed herein, e.g., a drying temperature in a range from 50° C. to 200° C., or from 100° C. to 150° C., and drying at atmospheric pressure or sub-atmospheric pressure, e.g., less than 150 Torr, or less than 50 Torr.

Aspect 10. The process defined in any one of the preceding aspects, further comprising a step of deagglomerating the supported zinc dimolybdate hydroxide/silica complex, a step of milling the supported zinc dimolybdate hydroxide/silica complex, or both.

Aspect 11. The supported zinc dimolybdate hydroxide/silica complex produced by the process defined in any one of aspects 1-10.

Aspect 12. A supported zinc dimolybdate hydroxide/silica complex comprising (a) silica and (b) zinc dimolybdate hydroxide at an amount in a range from 3 to 20 wt. % zinc, based on the total weight of the supported zinc dimolybdate hydroxide/silica complex; wherein at least 80 wt. % of the zinc dimolybdate hydroxide is present as crystalline form Zn₃Mo₂O₈(OH)₂.

Aspect 13. The process or complex defined in any one of the preceding aspects, wherein the silica is characterized by any suitable median particle size (d50), or a median particle size (d50) in any range disclosed herein, e.g., from 0.2 to 5 μm, from 0.2 to 25 μm, from 0.2 to 1 μm, or from 0.25 to 0.8 μm.

Aspect 14. The process or complex defined in any one of the preceding aspects, wherein the silica is characterized by any suitable d100 particle size, or a d100 particle size in any range disclosed herein, e.g., from 0.6 to 10 μm, from 0.6 to 5μm, from 0.6 to 4 μm, from 0.7 to 4 μm, or from 0.7 to 3.5 μm.

Aspect 15. The process or complex defined in any one of the preceding aspects, wherein the silica is characterized by any suitable d10 particle size, or a d10 particle size in any range disclosed herein, e.g., from 0.08 to 1 μm, from 0.08 to 0.5 μm, from 0.1 to 0.5 μm, or from 0.1 to 0.4 μm.

Aspect 16. The process or complex defined in any one of the preceding aspects, wherein the silica is characterized by any suitable BET surface area, or a BET surface area in any range disclosed herein, e.g., from 2 to 20 m²/g, from 4 to 15 m²/g, from 4 to 12 m²/g, from 5 to 15 m²/g, or from 5 to 13 m²/g.

Aspect 17. The process or complex defined in any one of the preceding aspects, wherein the silica is fused silica, or spherical silica, or spherical fused silica.

Aspect 18. The supported zinc dimolybdate hydroxide/silica complex defined in any one of aspects 11-17, wherein the supported zinc dimolybdate hydroxide/silica complex contains any suitable amount of zinc, or an amount in any range disclosed herein, e.g., from 3 to 20 wt. %, from 3 to 18 wt. %, from 4 to 16 wt. %, or from 5 to 15 wt. %.

Aspect 19. The supported zinc dimolybdate hydroxide/silica complex defined in any one of aspects 11-18, wherein the supported zinc dimolybdate hydroxide/silica complex contains any suitable amount of molybdenum, or an amount in any range disclosed herein, e.g., from 3 to 20 wt. %, from 3 to 18 wt. %, from 4 to 16 wt. %, or from 5 to 15 wt. %.

Aspect 20. The supported zinc dimolybdate hydroxide/silica complex defined in any one of aspects 11-19, wherein any suitable amount of the zinc dimolybdate hydroxide, or an amount in any range disclosed herein, e.g., at least 80 wt. %, at least 85 wt. %, at least 90 wt. %, or at least 95 wt. %, is present as Zn₃Mo₂O₈(OH)₂.

Aspect 21. The supported zinc dimolybdate hydroxide/silica complex defined in any one of aspects 11-20, wherein the supported zinc dimolybdate hydroxide/silica complex is characterized by any suitable median particle size (d50), or a median particle size (d50) in any range disclosed herein, e.g., from 0.3 to 6 μm, from 0.3 to 2 μm, from 0.4 to 1.8 μm, or from 0.5 to 1.7 μm.

Aspect 22. The supported zinc dimolybdate hydroxide/silica complex defined in any one of aspects 11-21, wherein the supported zinc dimolybdate hydroxide/silica complex is characterized by any suitable d100 particle size, or a d100 particle size in any range disclosed herein, e.g., from 1 to 12 μm, from 1 to 8 μm, from 1.5 to 7 μm, from 2 to 7 μm, or from 2.5 to 6 μm.

Aspect 23. The supported zinc dimolybdate hydroxide/silica complex defined in any one of aspects 11-22, wherein the supported zinc dimolybdate hydroxide/silica complex is characterized by any suitable d10 particle size, or a d10 particle size in any range disclosed herein, e.g., from 0.1 to 1.5 μm, from 0.1 to 0.8 μm, from 0.1 to 0.7 μm, or from 0.2 to 0.6 μm.

Aspect 24. The supported zinc dimolybdate hydroxide/silica complex defined in any one of aspects 11-23, wherein the supported zinc dimolybdate hydroxide/silica complex is characterized by any suitable span ((d90-d10)/d50), or a span in any range disclosed herein, e.g., from 1.5 to 5, from 1.5 to 4.5, or from 2 to 4.

Aspect 25. The supported zinc dimolybdate hydroxide/silica complex defined in any one of aspects 11-24, wherein the supported zinc dimolybdate hydroxide/silica complex is characterized by any suitable BET surface area, or a BET surface area in any range disclosed herein, e.g., from 3 to 20 m²/g, from 3 to 15 m²/g, from 3 to 12 m²/g, from 4 to 13 m²/g, or from 4 to 10 m²/g.

Aspect 26. The supported zinc dimolybdate hydroxide/silica complex defined in any one of aspects 11-25, wherein the supported zinc dimolybdate hydroxide/silica complex is spherical.

Aspect 27. A polymer composition (or formulation) comprising (a) a polymer and (b) the supported zinc dimolybdate hydroxide/silica complex defined in any one of aspects 11-26.

Aspect 28. The polymer composition defined in aspect 27, wherein the amount of the supported zinc dimolybdate hydroxide/silica complex is any suitable amount, or an amount in any range disclosed herein, e.g., from 1 to 50 phr, from 5 to 50 phr, from 2 to 40 phr, from 5 to 40 phr, from 10 to 50 phr, from 10 to 40 phr, from 10 to 30 phr, or from 15 to 40 phr.

Aspect 29. The polymer composition defined in aspect 27 or 28, wherein the polymer comprises any suitable polymer, or any polymer disclosed herein, e.g., a thermoplastic, a thermoset, or a combination thereof.

Aspect 30. The polymer composition defined in aspect 27 or 28, wherein the polymer comprises a polyvinylidene chloride (PVDC), a polyvinyl chloride (PVC), a chlorinated polyvinyl chloride (CPVC), a polyvinylidene fluoride (PVDF), a polytetrafluoroethylene (PTFE), an ethylene chlorotrifluoroethylene (ECTFE), or any combination thereof.

Aspect 31. The polymer composition defined in aspect 27 or 28, wherein the polymer comprises a rigid PVC.

Aspect 32. The polymer composition defined in aspect 27 or 28, wherein the polymer comprises a flexible PVC.

Aspect 33. The polymer composition defined in aspect 27 or 28, wherein the polymer comprises a plasticized or non-plasticized PVC.

Aspect 34. The polymer composition defined in aspect 27 or 28, wherein the polymer comprises an epoxy resin.

Aspect 35. The polymer composition defined in aspect 27 or 28, wherein the polymer comprises a bisphenol A epoxy resin, a bisphenol F epoxy resin, a bisphenol S epoxy resin, a phenol novolac epoxy resin, a cresol novolac epoxy resin, a bisphenol A novolac epoxy resin, a bisphenol F novolac epoxy resin, a diphenylethylene epoxy resin, an epoxy resin having a triazine skeleton, an epoxy resin having a fluorene skeleton, a triphenylmethane epoxy resin, a biphenyl epoxy resin, a xylylene epoxy resin, a biphenyl aralkyl epoxy resin, a naphthalene epoxy resin, a dicyclopentadiene epoxy resin, an alicyclic epoxy resin, or any combination thereof

Aspect 36. The polymer composition defined in any one of aspects 27-35, wherein the polymer composition further comprises an additive, the additive comprising a stabilizer, a lubricant, an inorganic flame retardant (e.g., aluminum trihydrate or magnesium hydroxide), a filler, a colorant, a curing agent, a catalyst or accelerator, or a fiber (e.g., glass fiber, carbon fiber, paper fiber, nonwoven fiber), as well as any combination thereof.

Aspect 37. The process, complex, or composition defined in any one of aspects 1-36, wherein the complex, or the silica, or both the complex and the silica, comprise(s) a surface treatment (e.g., a silane surface treatment).

Aspect 38. An article of manufacture comprising the polymer composition defined in any one of aspects 27-37.

Aspect 39. The article defined in aspect 38, wherein the article comprises a wire or cable.

Aspect 40. The article defined in aspect 38, wherein the article comprises a printed circuit board.

We claim:

1. A process for producing a supported zinc dimolybdate hydroxide/silica complex, the process comprising:
(i) reacting a zinc compound and molybdenum trioxide (MoO₃) in an aqueous system to form a reaction mixture; and
(ii) contacting the reaction mixture with silica to form the supported zinc dimolybdate hydroxide/silica complex.

2. The process of claim 1, wherein:
step (i) and step (ii) are conducted independently at a temperature in a range from 20° C. to 95° C.;
the zinc compound comprises zinc oxide; and
the zinc oxide and the molybdenum trioxide are reacted at a molar ratio of Zn:Mo from 1:1 to 2:1.

3. A process for producing a supported zinc dimolybdate hydroxide/silica complex, the process comprising:
contacting zinc dimolybdate hydroxide and silica in an aqueous system to form the supported zinc dimolybdate hydroxide/silica complex.

4. The process of claim 3, wherein the supported zinc dimolybdate hydroxide/silica complex is formed at a temperature in a range from 15° C. to 95° C.

5. The process of claim 1, further comprising a step of removing the supported zinc dimolybdate hydroxide/silica complex from water.

6. The process of claim 1, further comprising:
drying the supported zinc dimolybdate hydroxide/silica complex;
deagglomerating the supported zinc dimolybdate hydroxide/silica complex;
milling the supported zinc dimolybdate hydroxide/silica complex; or any combination thereof.

7. The supported zinc dimolybdate hydroxide/silica complex produced by the process of claim 1.

8. A supported zinc dimolybdate hydroxide/silica complex comprising:
(a) silica; and
(b) zinc dimolybdate hydroxide at an amount in a range from 3 to 20 wt. % zinc, based on the total weight of the supported zinc dimolybdate hydroxide/silica complex;
wherein at least 80 wt. % of the zinc dimolybdate hydroxide is present as crystalline form Zn₃Mo₂O₈(OH)₂.

9. The complex of claim 8, wherein the silica is characterized by:
a d50 particle size from 0.2 to 5 um;
a d100 particle size from 0.6 to 10 um;
a d10 particle size from 0.08 to 1 um; and
a BET surface area from 2 to 20 m²/g.

10. The complex of claim 8, wherein:
the silica is fused silica;
the silica is spherical silica; or
both.

11. The complex of claim 8, wherein:
the supported zinc dimolybdate hydroxide/silica complex contains from 4 to 16 wt. % zinc;
the supported zinc dimolybdate hydroxide/silica complex contains from 3 to 20 wt. % molybdenum; and
at least 90 wt. % of the zinc dimolybdate hydroxide is present as Zn₃Mo₂O₈(OH)₂.

12. The complex of claim 8, wherein the supported zinc dimolybdate hydroxide/silica complex is characterized by:
a d50 particle size from 0.3 to 6 μm;
a d100 particle size from 1 to 12 μm;
a d10 particle size from 0.1 to 1.5 μm;
a span ((d90-d10)/d50) from 1.5 to 5; and
a BET surface area from 3 to 20 m²/g.

13. The complex of claim 8, wherein the supported zinc dimolybdate hydroxide/silica complex is spherical.

14. A polymer composition comprising:
(a) a polymer; and
(b) the supported zinc dimolybdate hydroxide/silica complex of claim 8.

15. The polymer composition of claim 14, wherein the polymer comprises a thermoplastic polymer.

16. The polymer composition of claim 14, wherein the polymer comprises a thermoset polymer.

17. The polymer composition of claim 14, wherein the polymer comprises a rigid PVC or a flexible PVC.

18. The polymer composition of claim 14, wherein the polymer comprises an epoxy resin.

19. The polymer composition of claim 14, wherein:
an amount of the supported zinc dimolybdate hydroxide/silica complex is in a range from 1 to 50 phr; and
the polymer composition further comprises an additive, the additive comprising a stabilizer, a lubricant, an inorganic flame retardant, a filler, a colorant, a curing agent, a catalyst or accelerator, a fiber, or any combination thereof

20. An article of manufacture comprising the polymer composition of claim 14.
